(19) United States
(12) Patent Application Publication
(10) Pub. No.: US 2019/0036402 A1
(43) Pub. Date: Jan. 31, 2019

(54) ROTOR FOR AN AXIAL FLUX ELECTROMAGNETIC MOTOR OR GENERATOR WITH SEMI-EMBEDDED MAGNETS AND AXIAL HOLDING MEANS

(71) Applicant: WHYLOT SAS, CAMBES (FR)

(72) Inventors: Huguette TIEGNA, FIGEAC (FR); Loïc MAYEUR, Saint-Sentin (FR); Romain RAVAUD, LABASTIDE MURAT (FR)

(73) Assignee: WHYLOT SAS, CAMBES (FR)

(21) Appl. No.: 16/073,722

(22) PCT Filed: Mar. 9, 2017
(86) PCT No.: PCT/FR2017/000047

§ 371 Date: Jul. 27, 2018

(30) Foreign Application Priority Data
Mar. 14, 2016 (FR) 1600419

(51) Int. Cl. H02K 1/28; H02K 1/27; H02K 21/24

(52) U.S. Cl. CPC H02K 1/28; H02K 21/24; H02K 1/2793

(57) ABSTRACT

This invention relates to a rotor (1) with semi-embedded magnets for an axial flux motor or generator, comprising a body (2) in the form of a disc with two circular faces, the disc having an inner and an outer periphery which delimit a recess for a rotating shaft (7), at least two permanent magnets (2a) being applied against at least one of the two circular faces of the body (2) being held on said face by holding means (3a, 5, 5a, 6, 6a), with a gap between the at least two magnets (2a). The holding means (3, 3a, 5, 5a, 6, 6a) are in the form of at least one lateral, axial holding means (3, 3a) housed in the gap comprising at least one tenon (3a) locally covering at least one of the two magnets (2a) or an axial holding means (5a, 6a) forming a ring.

This invention relates to a rotor for an axial flux electromagnetic motor or generator rotating at high rotating speeds and an electromagnetic motor or generator provided with such a rotor.

This invention has an advantageous but non-limiting application for an electric motor supplying high power with a high rotating speed of the rotor which is obtained by the specific characteristics of the rotor according to this invention. Such a motor can be used for example as an electric motor in a motor vehicle that is entirely electric or hybrid.

Advantageously but not in a limited manner, the electromagnetic generator or motor can comprise at least one rotor surrounded by two stators, with these elements able to be superimposed in relation to one another by being separated by at least one air gap on the same shaft.

In high-speed applications, it is necessary to have not only a compact system made possible by reducing the mass and the size of the axial motor for optimum output, but also very good mechanical resistance of the rotating portion, i.e. the rotor, in order to improve the reliability of the system.

A rotor with semi-embedded magnets intended for an axial flux electromagnetic machine is known. Such a rotor comprises a body in the form of a disc having two circular faces connected by a thickness, the disc being delimited between an outer periphery and an inner periphery delimiting a recess for a rotating shaft.

At least two permanent magnets are applied against at least one of the two circular faces of the body referred to as the support face. For a single air gap rotor intended to be associated with a stator a single circular face of the body carries magnets while for a rotor with two air gaps with a respective stator, it is both faces that carry magnets.

The magnets are each maintained on the face or their respective face by means of maintaining, with an interval left between said at least two magnets on the same face.

For the stator or each stator, the latter carry winding elements that comprise a tooth carrying a coil, with the tooth being surrounded on each one of its sides by a notch, with a good conductive metal wire being wound on the tooth in order to form the coil.

When the series of windings are electrically powered, the rotor that is secured to the output shaft of the motor is subjected to a torque resulting from the electromagnetic field, with the magnetic flux created being an axial flux for an axial flux electric machine.

For a high-power motor, the rotor rotates at high rotation speeds. The main disadvantage of a motor with a high rotation speed resides in the high probability of a detaching of the magnet or magnets from the rotor as well as at least partial breakage of the rotor. The rotor of such a motor must therefore be able to withstand high rotation speeds.

Document JP-A-2008/199811 describes a rotor intended for an axial flux electromagnetic generator or a motor, the rotor comprising a body in the form of a disc having two circular faces connected by a thickness, the disc being delimited between an outer periphery and an inner periphery, the inner periphery delimiting a recess for a rotating shaft, at least two permanent magnets being applied against at least one of the two circular faces of the body referred to as the support face by each being maintained on said face by means of maintaining, with an interval left between said at least two magnets. In this document, the magnets are not semi-embedded but entirely surrounded by elements such as a magnetic plate and an element of magnetic material. It follows that, in this document, the magnets are entirely housed in a cavity and do not protrude from a side of this cavity as would be the case with semi-embedded magnets.

Document US-A-2014/292117 describes a rotor with magnets with at least two permanent magnets applied against at least one of the two circular faces of the body referred to as the support face by each being maintained on said face by means of maintaining. In this document, the magnets are not semi-embedded and the means of maintaining do not have an effect of axial maintaining on the magnets but simply surround them.

Document EP-A-2 632 027 describes a rotor with magnets with at least two permanent magnets applied against at least one of the two circular faces of the body referred to as the support face by each being maintained on said face by means of maintaining. In this document, the magnets are not semi-embedded. Means of maintaining certainly have an axial maintaining effect on the magnets through the collars but these collars are not applied on the portions protruding from the magnets.

The semi-embedded magnets protrude from their respective housing. The semi-embedded magnets have significant advantages in particular with regards to the minimisation of the losses by eddy currents in the rotor but also mechanical advantages, for example in order to retain a minimum thickness of adhesive or solder under the magnets and on the insertion walls when these elements are welded or glued.

However, these semi-embedded magnets have the great disadvantage of not being sufficiently maintained in the axial direction of the rotor, given that they are not covered by an element, in particular a magnetic element. This great disadvantage hinders the use of semi-embedded magnets.

The problem at the base of this invention is to design a rotor for an axial flux electromagnetic machine that can maintain the permanent magnet or magnets in their respective housing that they effectively support by preventing the magnets from becoming detached from the rotor, with the magnets being semi-embedded magnets, i.e. extending beyond their respective housing.

To this effect, according to the invention a rotor is provided intended for an axial flux electromagnetic machine, with the rotor comprising a body in the form of a disc having two circular faces connected by a thickness, the disc being delimited between an outer periphery and an inner periphery, the inner periphery delimiting a recess for a rotating shaft, at least two permanent magnets being applied against at least one of the two circular faces of the body referred to as the support face by each being maintained on said face by means of maintaining, with an interval left between said at least two magnets, characterised in that the magnets are semi-embedded magnets, the means of maintaining being in the form of at least one lateral means of axial maintaining housed in the interval comprising at least one tenon locally and directly covering at least one of said at least two semi-embedded magnets or a means of axial maintaining extending circularly all around the inner and/or outer periphery of the body by forming a ring locally and directly covering at least one of said at least two semi-embedded magnets.

The technical effect obtained is better resistance of the semi-embedded magnets in the rotor in the axial direction which can be supplemented by means of radial maintaining.

This rotor with semi-embedded magnets is designed to reduce the losses in the rotor with the means of maintaining making it possible to retain the semi-embedded magnets and as such to overcome the effect of an axial force and, where applicable, of a centrifugal force that appears at very high speed.

Compared to the closest prior art shown in document JP-A-2008/199811, the rotor according to the invention can be suitable for semi-embedded magnets. In order to retain all of the advantages conferred by using semi-embedded magnets, the magnets should be covered as little as possible by means of maintaining.

This invention provides a solution that is suitable for any form of arrangement of semi-embedded magnets on the rotor.

Locally means that the covering of the semi-embedded magnets is limited which was not the case in document JP-A-2008/199811 where all of the magnets were entirely covered. Directly means that the means of maintaining are effective on the magnets themselves and not through the intermediary of an intermediate part that would cause all of the advantages procured by semi-embedded magnets to be lost.

The lateral means of axial maintaining act directly on the semi-embedded magnets. This results in an individual maintaining of each magnet on the rotor by at least one lateral means of axial maintaining that is dedicated to it.

Keep in mind that a ring that forms both a means of radial maintaining and a means of axial maintaining placed at the periphery of the body of the rotor cannot be assimilated to a fret. Indeed, a fret is always associated with a compensation of the centrifugal force and with a compression function by being an independent part of the body of the rotor and arranged at the outer periphery of this body. A fret has no action on an axial maintaining of semi-embedded magnets.

Inversely the means of axial maintaining in the form of a ring is part of the body. This means of axial maintaining in the form of a ring makes it possible to retain the semi-embedded magnets axially but compresses them very little or not at all. The axial maintaining element in the shape of a ring is part of the body disposed opposite to a collar. This axial maintaining element in the shape of a ring is arranged on the body before the semi-embedded magnets are secured to the body, with the insertion of the magnets carried out radially starting from the central portion of the body delimited by the inner periphery which can also carry an axial maintaining element.

The means of axial maintaining concentric to the rotor is not suggested or rendered evident by prior art, with such means of maintaining being in the form of a collar and exerting solely a radial and not axial maintaining. A collar already present for the absorption of the centrifugal forces can also be used as an abutment to the magnet or to the semi-embedded magnets against a radial movement of the semi-embedded magnets but not as an axial maintaining element.

Optionally, the invention further comprises at least one of any of the following characteristics:
when the means of axial maintaining extending circularly all around the inner and/or outer periphery of the body by forming a ring is present, said at least one means of axial maintaining is associated with a means of radial maintaining by being secured to the body. As such a radial and axial maintaining advantageously procured by the sale maintaining element is obtained, which is advantageous in terms of cost. This makes it possible to supplement the action of the lateral means of axial maintaining.
the means of axial maintaining is in the form of a collar around the periphery of the ring, with the collar having bevelled portions with regards to said at least two semi-embedded magnets,
said at least one lateral means of axial maintaining is an integral part of the body of the rotor or is an added part integral with the body of the rotor.
said at least one lateral means of axial maintaining is machined in the mass of the body of the rotor or glued, welded, screwed or crimped to the body of the rotor. This reinforces the solidity of the rotor.
said at least one lateral means of axial maintaining comprises one or several branches, the or each branch being secured with the body and separating said at least two semi-embedded magnets in a respective interval, the or each branch comprising at least one tenon extending as an ortho-radial protrusion from the branch and covering at least one portion of a face of at least one of said at least two semi-embedded magnets located the farthest away from and opposite the support face of the body, said at least one tenon abutting against the magnet preventing a separation movement of the associated magnet as axial separation from the body. As such, the lateral means of axial maintaining are housed between the semi-embedded magnets in intervals that can be left empty between the semi-embedded magnets and receiving these lateral means of axial maintaining. The tenon covers only the portion of the magnet sufficient to guarantee the maintaining thereof.
each one of said at least two semi-embedded magnets is associated with at least two tenons.
each tenon extends laterally from the two sides of the associated branch, a first lateral portion of the tenon covering at least one portion of one magnet of said at least two semi-embedded magnets and a second lateral portion of the tenon covering at least one portion of the other magnet.
when the rotor comprises a means of outer radial maintaining extending all around the outer periphery of the body, the means for outer radial maintaining is respectively connected to each branch, with portions in an arc or circle of the means of outer radial maintaining forming an abutment against a radial and axial displacement of one of said at least two semi-embedded magnets.
when the rotor does not comprise a means of outer radial maintaining extending all around the outer periphery of the body, the rotor is surrounded by a collar.
the rotor comprises an element for radial inner maintaining, with portions of an arc of circle of the means of inner radial maintaining forming an abutment against an axial displacement of one of said at least two semi-embedded magnets.
when the rotor comprises a means of inner radial maintaining, the means of inner radial maintaining to the body extends circularly all around the inner periphery of the body and is secured to the body.
when the body comprises one or several branches separating said at least two semi-embedded magnets in a respective interval and a means of inner and/or outer radial maintaining, the means of inner and/or outer radial maintaining is secured with the or each branch.
when the body comprises one or several branches separating said at least two semi-embedded magnets in a respective interval, the means of inner radial maintaining is secured with the or each branch.
said at least two semi-embedded magnets are of a different shape and/or comprised of several parts forming magnetic poles or are part of a single-piece structure that has several magnetic poles. This embodiment is the closest to that of the closest prior with a moulded part carrying semi-embedded magnets.

However, even in this embodiment, the lateral means of axial maintaining of this invention have tenons that partially and directly cover the magnets of the structure while in the closest prior art shown in JP-A-2008/199811, elements were used that were inserted in the portions of a part covering the magnets.

In such an arrangement disclosed by this prior art, it was always possible for a magnet to become detached as it was not directly maintained, which is prevented in the framework of this invention due to a tenon that is specifically dedicated to a magnet. In addition by applying the characteristics disclosed in JP-A-2008/199811, to semi-embedded magnets, all of the advantages of semi-embedded magnets are annihilated.
said at least two semi-embedded magnets are in the form of quadrangular tiles with two sides of said at least two semi-embedded magnets extending radially and two sides of said at least two semi-embedded magnets extending in concentric arcs of a circle at the centre of the disc formed by the body.
the two circular faces of the body of the rotor each comprise at least two semi-embedded magnets.
at least one single-piece circular structure is formed from said at least two semi-embedded magnets, the single-piece structure in the case of a single single-piece structure forming a circular ring on a circular face of the body or two single-piece structures in the case of several single-piece structure forming two concentric circular rings of semi-embedded magnets with a circular ring on each one of the circular faces of the body, with the two single-piece structures being spaced apart by a separation element that is part of the body of the rotor, said at least two semi-embedded magnets of the single-piece structure or of the two single-piece structures in the form of rings being maintained by a lateral means of axial maintaining or by a means of axial maintaining forming a ring, where applicable with a means of radial maintaining forming a ring.

The invention also relates to an axial flux motor or generator comprising one or several air gaps that respectively separate one or several rotors and one or several stators carrying a winding, characterised in that the motor or the generator comprises at least one such rotor.

Advantageously, the motor or the generator comprises at least two stators connected in series or in parallel.

Advantageously, said at least two stators are offset by an angle alpha with respect to one another.

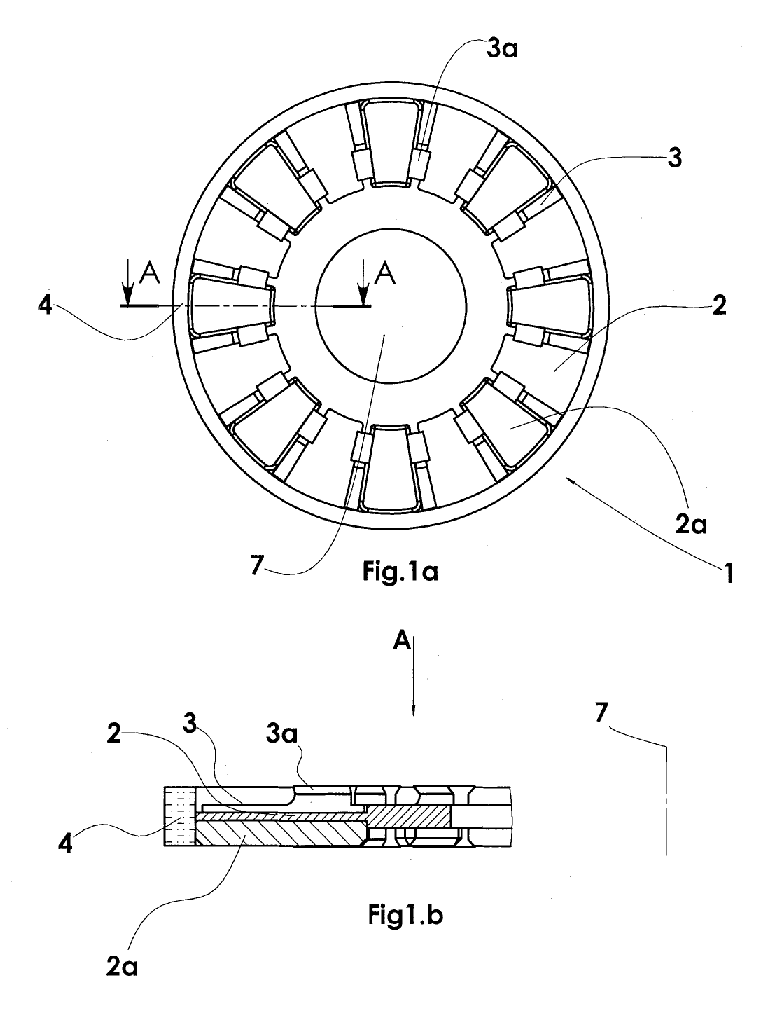

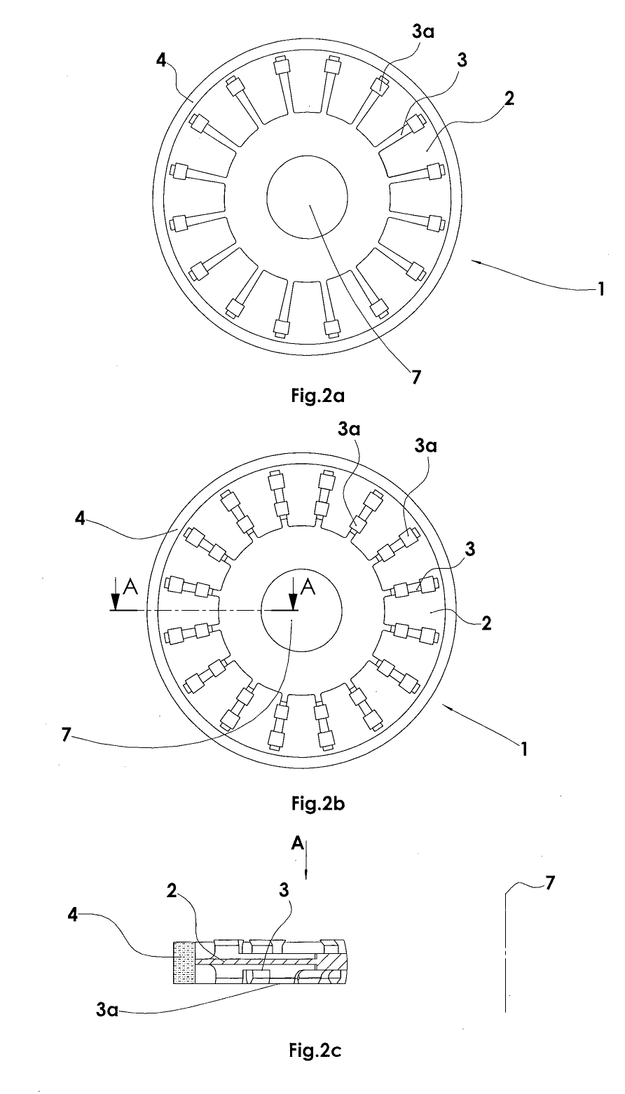

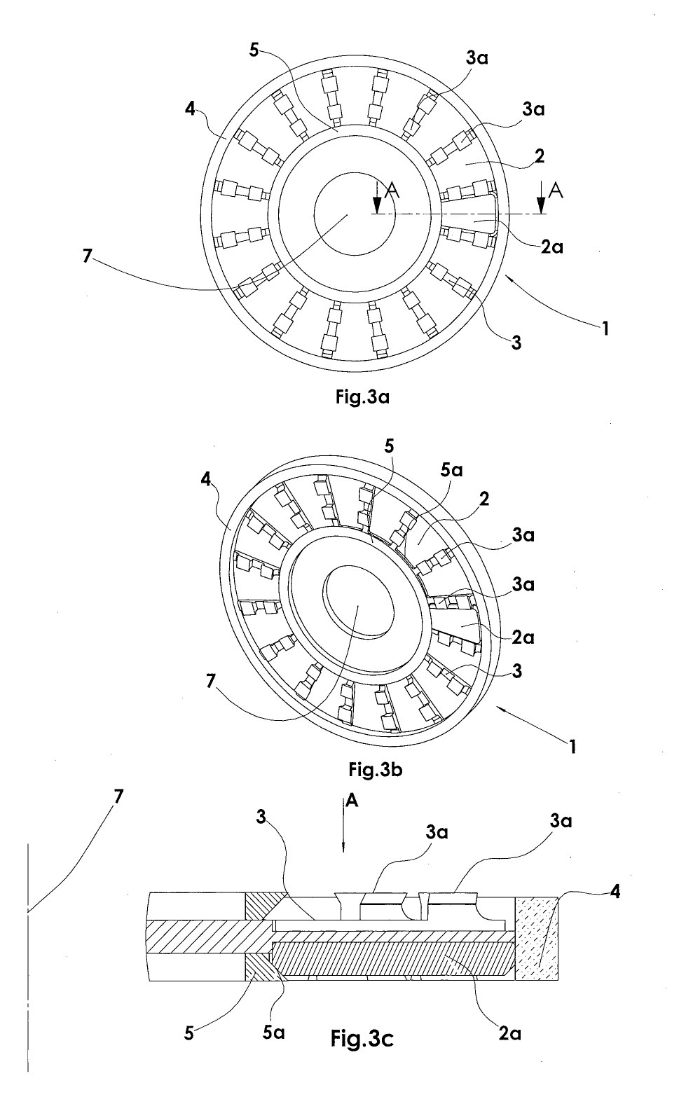

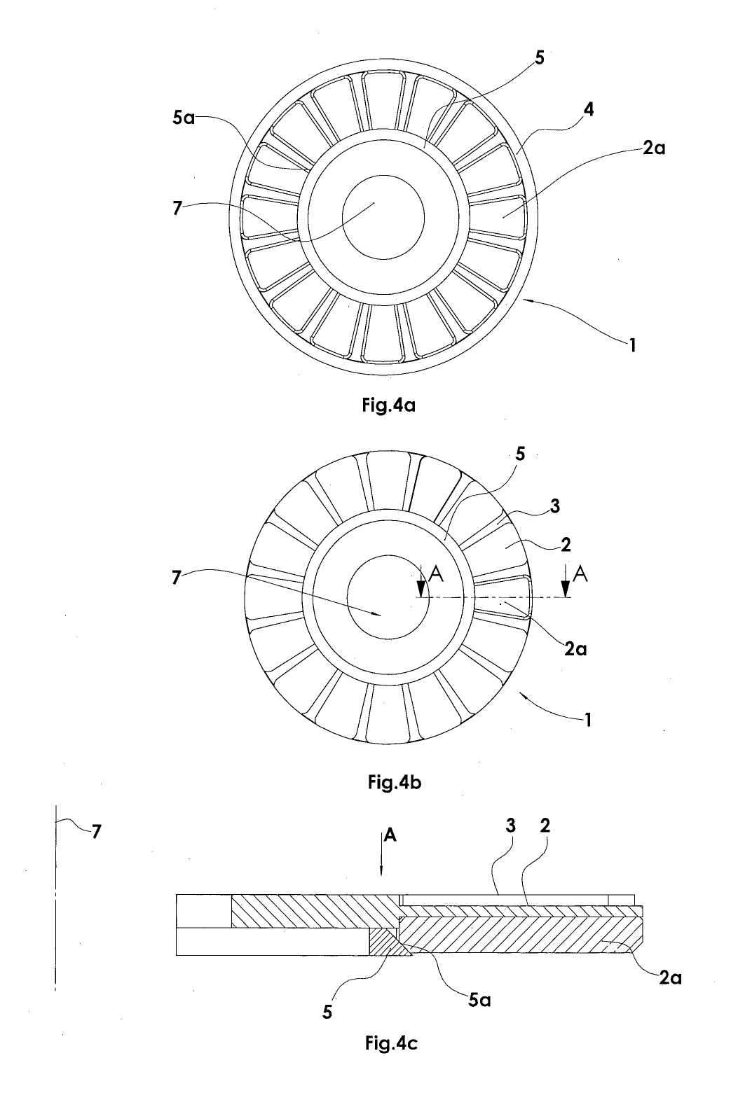

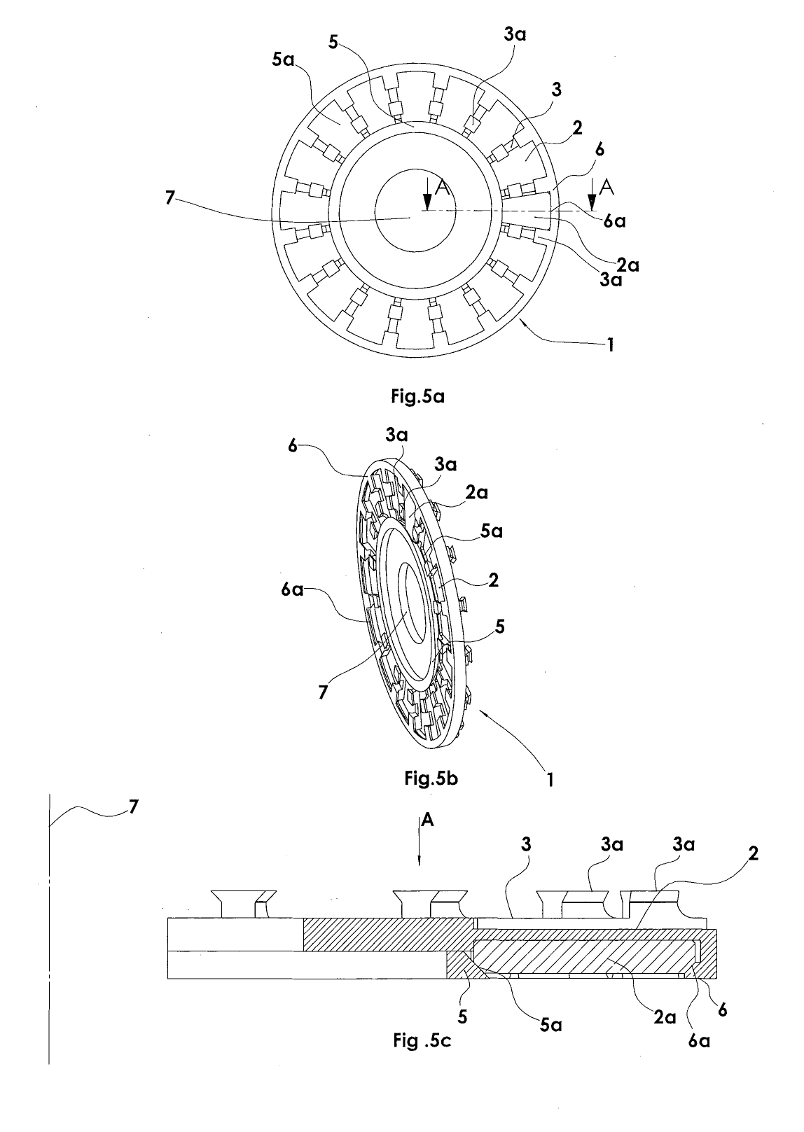

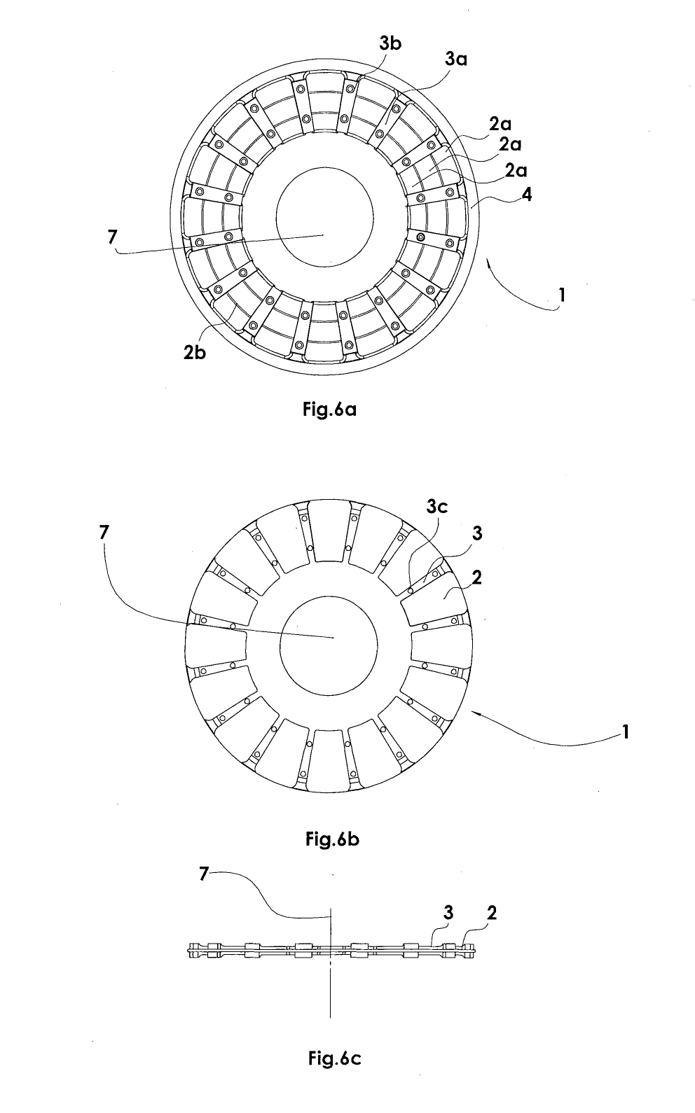

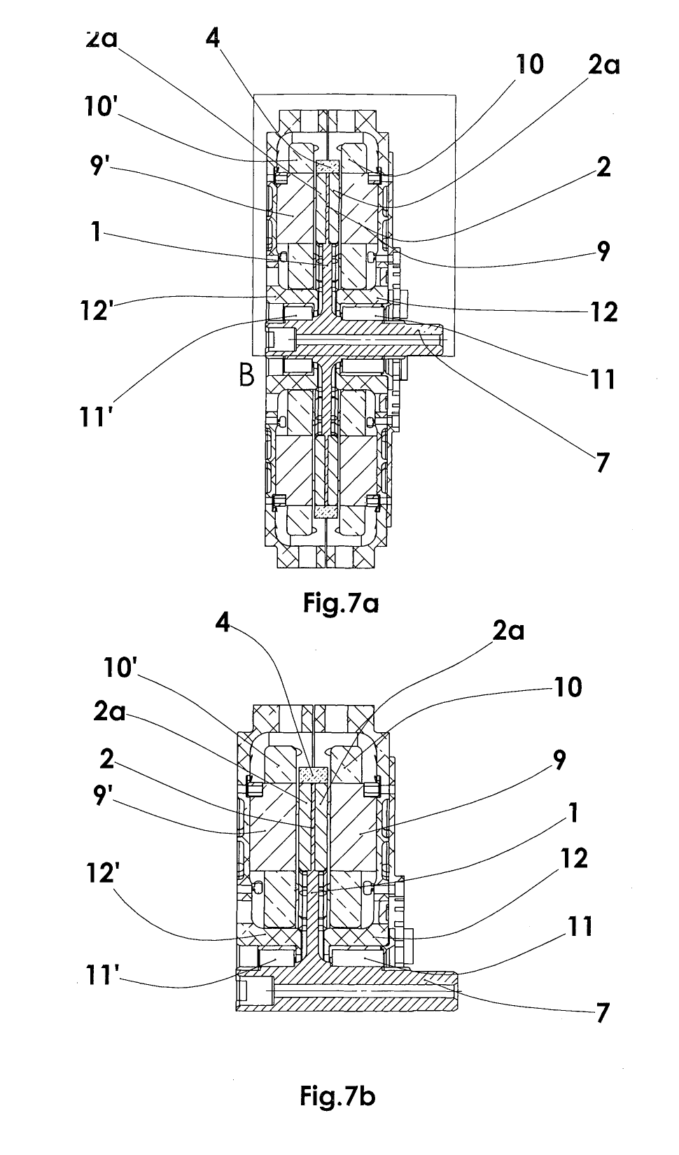

Other characteristics, purposes and advantages of this invention shall appear when reading the following detailed description and with regard to the accompanying drawings provided as non-limiting examples and wherein:
FIG. 1a diagrammatically shows a front view of a rotor intended for an axial flux electric machine according to a first embodiment of this invention, with lateral means of axial maintaining of semi-embedded magnets of the rotor being shown in this figure, with FIG. 1b being a radial cross-section of FIG. 1a with magnets on each face of the rotor, with the magnets of one side having been removed in order to show the maintaining elements,
FIGS. 2a and 2b diagrammatically show a front view of a rotor intended for an axial flux electric machine according to the second and third embodiments of this invention, with the lateral means of axial maintaining of semi-embedded magnets of the rotor being shown in these figures, with the body of the rotor carrying the semi-embedded magnet or magnets and being surrounded by a collar in these figures, FIG. 2c being a radial cross-section of FIG. 2a this without the magnets in order to show the maintaining elements,
FIGS. 3a and 3b diagrammatically show a view of a face of a rotor intended for an axial flux electric machine according to a fourth and fifth embodiment of this invention, with two lateral means of axial maintaining of semi-embedded magnets of the rotor between two semi-embedded magnets being shown in these figures, with the body of the rotor carrying the semi-embedded magnet or magnets and being surrounded by a collar and a means concentric to the rotor of axial maintaining being shown in these figures, FIG. 3c being a radial cross-section of FIG. 3a with magnets on each radial face of the rotor, with the magnets of one face having been removed in order to show the maintaining elements,
FIGS. 4a and 4b diagrammatically show a view of a face of a rotor intended for an axial flux electric machine according to a sixth and seventh embodiment of this invention, a means of axial maintaining concentric to the rotor being shown in these figures, FIG. 4c being a radial cross-section of FIG. 4a with magnets on each face of the rotor,
FIGS. 5a and 5b diagrammatically show a view of a face of a rotor intended for an axial flux electric machine according to an eighth embodiment of this invention, with two tenons being a part of the lateral means of axial maintaining of semi-embedded magnets of the rotor between two semi-embedded magnets being shown in these figures, the body of the rotor carrying the semi-embedded magnet or magnets and being surrounded by a means of radial maintaining concentric to the rotor being shown in these figures, with FIG. 5c being a radial cross-section of FIG. 5a with magnets on each face of the rotor,
FIGS. 6a and 6b diagrammatically a view of a face of a rotor intended for an axial flux electric machine according to a ninth and tenth embodiment of this invention, with two lateral means of axial maintaining of semi-embedded magnets of the rotor between two semi-embedded magnets being shown in these figures, with these lateral means being removable from the body, the body of the rotor carrying the semi-embedded magnet or magnets and being surrounded by a collar in FIG. 6a, with FIG. 6c being a view of the outer edge of the rotor,
FIGS. 7a and 7b diagrammatically show a longitudinal cross-section view of an electromagnetic motor comprising two rotors and a stator, with the rotors being in accordance with one of the embodiments of a rotor described hereinabove, FIG. 7b being enlarged with respect to FIG. 7a.

The figures are provided as examples and do not limit the invention. They form diagrammatical block representations intended to facilitate the understanding of the invention and are not necessarily to scale of the practical applications. In particular the dimensions of the various parts do not represent reality.

In reference to all of the figures, this invention relates to a rotor 1 with semi-embedded magnets intended for an axial flux electromagnetic machine. The magnets are semi-inserted for the purpose of minimising the losses by eddy current in the rotor and also for mechanical needs, for example in order to retain a minimum thickness of adhesive or of solder under the semi-embedded magnets and on the insertion walls when these elements are welded or glued.

The rotor 1 comprises a body 2 in the form of a disc having two circular faces connected by a thickness, the disc being delimited between an outer periphery and an inner periphery. The inner periphery delimits a recess for a rotating shaft 7.

At least two semi-embedded magnets 2a are applied against at least one of the two circular faces of the body 2 referred to as the support face by each being maintained on said face by means of maintaining 3a, 5, 5a, 6, 6a, an interval being left between said at least two semi-embedded magnets 2a. The semi-embedded magnets can be part of a concentric structure by being integrated therein or can be unitary.

According to the invention, the means of maintaining 3, 3a, 5a, 6a are in the form of at least one lateral means of axial maintaining 3, 3a. In this case, the lateral means of axial maintaining 3, 3a is housed in the interval by comprising at least one tenon 3a locally and directly covering at least one of said at least two semi-embedded magnets 2a. This is shown in particular in FIGS. 1a, 2a, 2b, 3a, 3b, 5a and 5b, 6a and 6b.

Still according to the invention, the means of maintaining 3, 3a, 5a, 6a are in the form of a means of axial maintaining 5a, 6a extending circularly all around the inner and/or outer periphery of the body by forming a ring, locally and directly covering at least one of said at least two semi-embedded magnets. This is shown in FIGS. 4a, 4b and 5b.

In FIGS. 1b and 2c, a means of axial maintaining 3a is shown without the presence of the associated magnet 2a. In FIGS. 3c and 4c, a means of axial maintaining 5 of the magnets extending circularly all around the inner periphery is shown. In this mode of configuration of the means of axial maintaining 5, the latter carries a bevelled portion 5a bearing against a portion which itself is bevelled of the magnet 2a.

In FIG. 5c, a means of axial maintaining 5 of the magnets 2a is shown extending circularly all around the inner periphery with a bevelled portion 5a bearing against a portion that itself is bevelled of the magnet 2a. This means of axial maintaining 5 of said at least two semi-embedded magnets 2a cooperates for each magnet with a means of axial maintaining 6 extending circularly all around the outer periphery of the body by forming a ring. In this mode of configuration of the means of axial maintaining 6, the latter carries a bevelled portion 6a bearing against a portion that is itself bevelled of a semi-embedded magnet 2a, this towards the outer periphery of the rotor.

These bevelled portions 5a, 6a of means of axial maintaining 5, 6 can form a collar around the inner or outer periphery of the ring, with the bevelled portions 5a, 6a facing said at least two semi-embedded magnets 2a.

In FIG. 6c, means of lateral maintaining 3 of the magnets 2a are shown.

The means of lateral maintaining 3, 3a can be associated with means of axial maintaining 5a, 6a in the form of a ring extending circularly over one of the peripheries or over both peripheries. Alternatively, the lateral means of maintaining 3, 3a can be present without the axial means of maintaining 5a, 6a in the form of one or two rings concentric to the body 2 of the rotor 1 being present or inversely.

When one or several means of axial maintaining 5a, 6a extending circularly all around the inner and/or outer periphery of the body 2 by forming a ring are present, which is not always the case, at least one means of axial maintaining 5a, 6a can be associated with a means of radial maintaining 5, 6 by being secured to the body 2.

This is shown in particular in FIG. 3b. In this case, portions 5a in an arc of circle of the means of inner radial maintaining 5 can form an abutment against an axial and/or radial displacement of one of said at least two semi-embedded magnets 2a.

Said at least one lateral means of axial maintaining 3, 3a can be an integral part of the body 2 of the rotor 1 and/or can be an added part integral with the body of the rotor 1. This lateral means of axial maintaining 3, 3a can be machined in the mass of the body 2 of the rotor 1, glued, welded, screwed or crimped to the body 2 of the rotor 1.

In embodiments according to the invention, said at least one lateral means of axial maintaining 3, 3a can include one or several branches 3. The or each branch 3 can be integral with the body 2 and separate said at least two semi-embedded magnets 2a in a respective interval.

The or each branch 3 can include at least one tenon 3a extending as an ortho-radial protrusion from the branch 3 and covering at least one portion of a face of at least one of said at least two semi-embedded magnets 2a located the furthest away from and opposite the support face carried by the body 2. This concerns the face of said at least one magnet 2a which is opposite that applied against the support face carried by the body 2.

In this position, said at least one tenon 3a abuts against the magnet 2a preventing a separation movement of the associated magnet 2a in the axial direction of the body 2.

For a means of axial maintaining 5a, 6a extending circularly all around the inner and/or outer periphery of the body by forming a ring, this means of axial maintaining 5a, 6a can have a groove wherein an edge penetrates, either the outermost or the innermost, of the semi-embedded magnets 2a, with this groove not able to be seen in the figures.

In FIG. 1a, in a first optional embodiment, each tenon 3a extends laterally from the two sides of the associated branch 3. A first lateral portion of the tenon 3a covers at least one portion of a magnet of said at least two semi-embedded magnets 2a and a second lateral portion of the tenon 3a covers at least one portion of the other magnet.

In FIG. 2a, in a second optional embodiment, each tenon 3a is located at an outermost end to the body 2 of the branch 3. The branch 3 is adjacent to a collar 4 at its outermost end.

In FIG. 2b, in a third optional embodiment, there are two tenons 3a per branch 3, with the two tenons 3a being arranged successively in the length of the branch 3 with the free end of each branch 3 not reaching the collar 4.

In FIGS. 3a and 3b, in the fourth and fifth optional embodiments, there are two tenons 3a per branch 3, with the branches 3 extending between, on the one hand, a means of axial and/or radial maintaining 5, 5a that is circular all around the inner periphery by forming a ring and, on the other hand, a collar 4 extending at the outer periphery of the body 2 of the rotor 1.

In FIGS. 4a and 4b, in a sixth and seventh optional embodiment, there are no lateral means of axial maintaining but only one or several means of axial maintaining 5a, 6a that are circular extending all around respectively inner or outer peripheries of the body 2 by forming a ring.

In FIGS. 5a and 5b, in an eighth optional embodiment, lateral means of axial maintaining with branches 3 and tenons 3a are combined with two means of axial maintaining 5a, 6a that are circular extending all around respectively inner or outer peripheries of the body 2 by forming a ring. The branches 3 are connected to an end with the inner means of axial maintaining 5a and the outer means of maintaining 6a, for the latter by the intermediary of a connecting element 6b.

In FIGS. 6a and 6b, in ninth and tenth optional embodiments, the tenons 3a can be removed from the branches 3 by being fixed on the branches 3 in at least one point, advantageously two points and preferably one point 3c towards the inner end of the branch 3 and one point 3b towards an outer end of the branch 3 in relation to the body 2. An outer collar 4 is provided in FIG. 6a.

The collar 4 made of composite material can be formed from fibres or strips chosen from glass fibres, carbon, polymer or mineral fibres.

The constituent fibres or strips can be of different natures of dimensions. It can, for example, be mixed with glass fibres of a different composition, plastic fibres, for example made of PEEK, polyaramide or composite fibres.

When the rotor 1 comprises a means of outer radial maintaining 6 extending all around the outer periphery of the body 2, the means for outer radial maintaining 6 is respectively connected to each branch 3, with portions in an arc or circle of the means of outer radial maintaining 6 forming an abutment against a radial displacement of one of the at least two semi-embedded magnets 2a.

It is advantageous to combine this means of outer radial maintaining with a means of outer axial maintaining that advantageously forms the same element, with an axial maintaining then being provided with the radial maintaining.

As mentioned hereinabove, when the rotor 1 does not comprise a means of outer radial maintaining 6 extending all around the outer periphery of the body 2 by forming a ring, the rotor 1 is surrounded by a circular collar 4. This is however not mandatory.

When the body 2 comprises one or several branches 3 separating said at least two semi-embedded magnets 2a in a respective interval and a means of inner 5a and/or outer 6a radial maintaining forming a ring, the means of inner 5a and/or outer 6a radial maintaining forming a ring can be secured with the or each branch 3.

In an optional embodiment, said at least two semi-embedded magnets 2a can have a different shape and/or be comprised of several parts forming magnetic poles. Alternatively, said at least two semi-embedded magnets 2a can be part of a single-piece structure that has several magnetic poles.

Said at least two semi-embedded magnets 2a can have the form of quadrangular tiles with two sides of said at least two semi-embedded magnets 2a extending radially and two inner and outer sides of said at least two semi-embedded magnets 2a extending in concentric arcs of a circle at the centre of the disc formed by the body 2.

However, the semi-embedded magnets 2a can have various forms, for example having the form of polygonal tiles and not only quadrangular, for example triangular tiles. For a triangular tile, an apex of the triangle can point advantageously towards the centre of the rotor 1.

Said at least one magnet 2a can be chosen from ferrite magnets, rare earth magnets such as neodymium iron boron magnets or samarium cobalt magnets, aluminium, nickel and cobalt magnets, with or without thermoplastic binder.

It is on portions of the radial sides of said at least two semi-embedded magnets 2a that the tenons 3a, when present, perform their action, while it is on the inner and outer sides of said at least two semi-embedded magnets 2a that the one or several axial means of maintaining in the form of a ring or concentric rings 5a, 6a to the corps 2 of the rotor 1, when present, exert their action.

In a preferred embodiment of the invention shown in FIGS. 7a and 7b, the rotor 1 is intended for a motor or a poly-air gap generator by being associated with two stators that insert it between them. In this case, the two circular faces of the body 2 of the rotor 1 each comprise at least two semi-embedded magnets 2a.

In this preferred embodiment, said at least two semi-embedded magnets 2a comprise at least two concentric rings of semi-embedded magnets spaced apart by a separation element that is part of the body 2 of the rotor 1. Each magnet of the two rings can be maintained by a lateral means of axial maintaining 3, 3a and, where applicable by a means of axial and radial maintaining 5, 5a, 6, 6a.

On the rotor 1, the series of semi-embedded magnets can be formed by a single-piece structure comprising said at least two semi-embedded magnets 2a. The single-piece structure forms a circular ring on one of the circular faces of the body 2 of the rotor 1.

Alternatively, the body 2 of the rotor 1 can carry two single-piece structures forming two concentric circular rings of semi-embedded magnets spaced apart by a separation element that is part of the body 2 of the rotor 1. Each one of the two single-piece structures is then carried by a respective circular face of the body 2 of the rotor 1.

In both cases, said at least two semi-embedded magnets 2a of the single-piece structure or of the two single-piece structures in the form of rings can be maintained by a lateral means of axial maintaining 3, 3a or a means of axial maintaining in the form of a ring 5a, 6a, and where applicable a means of radial maintaining 5, 6 in the form of a ring.

The invention also relates to an axial flux generator or motor comprising one or several air gaps that respectively separate one or several rotors 1 and one or several stators carrying a winding, with the motor or the generator comprising at least one such rotor.

The rotor 1 can be associated with a single stator or can be associated with two stators by being inserted between the two stators. When there is more than one stator, the stators can be connected in series or in parallel. The stators can be offset by an angle with respect to one another.

FIGS. 7 and 7a show a rotor 1 comprising a body 2 with two series of semi-embedded magnets 2a arranged by being each semi-embedded on a circular face of the body 2 and by being separated from one another by a separation element that is part of the body 2. The rotor 1 is surrounded by two stators, with each stator forming an air gap with a respective series of semi-embedded magnets 2a.

The arrangement of the semi-embedded magnets can be chosen in order to establish an increased magnetic field on the side intended to be turned towards the stator associated facing, while the magnetic field is decreased or cancelled on the opposite side thereof. The loss of the magnetic field is as such reduced.

The rotor 1 comprises a rotating shaft 7 which extends perpendicularly to the circular faces of the rotor 1 by passing through the two stators. The rotor 1 is carried by at least two bearings 11, 11′, with a bearing 11, 11′ associated with a respective stator in order to allow for the rotation thereof with respect to the stators. In the non-limiting embodiment of FIGS. 7a and 7b, the outer periphery of the rotor 1 is surrounded by a collar 4.

Each stator comprises a magnetic circuit 9, 9′ associated with a winding 10, 10′. A carcass 12, 12′ makes it possible to protect the electromagnetic motor.

The invention is in no way limited to the embodiments described and shown which were given only as examples.

1. A rotor (1) intended for an axial flux electromagnetic generator or a motor, the rotor (1) comprising:
a body (2) in the form of a disc having two circular faces connected by a thickness, the disc being delimited between an outer periphery and an inner periphery, the inner periphery delimiting a recess for a rotating shaft (7),
at least two permanent magnets (2a) being applied against at least one of the two circular faces of the body (2), referred to as the support face,
by each being maintained on said face by means of maintaining (3a, 5, 5a, 6, 6a), with an interval left between said at least two magnets (2a),
characterised in that
the magnets are semi-embedded magnets,
the means of maintaining (3, 3a, 5, 5a, 6, 6a) being in the form of at least one lateral means of axial maintaining (3, 3a) housed in the interval comprising at least one tenon (3a) locally and directly covering at least one of said at least two semi-embedded magnets (2a) or a means of axial maintaining (5a, 6a) extending circularly all around the inner and/or outer periphery of the body by forming a ring locally and directly covering at least one of said at least two semi-embedded magnets (2a).

2. The rotor of claim 1, wherein, when the means of axial maintaining (5a, 6a) extending circularly all around the inner and/or outer periphery of the body (2) by forming a ring is present, said at least one means of axial maintaining (5a, 6a) is associated with a means of radial maintaining (5, 6) by being secured to the body (2).

3. The rotor of claim 2, wherein, the means of axial maintaining (5a, 6a) is in the form of a collar around the periphery of the ring, with the collar having bevelled portions with regards to said at least two semi-embedded magnets (2a).

4. The rotor (1) of claim 1, wherein said at least one lateral means of axial maintaining (3, 3a) is an integral part of the body (2) of the rotor (1) or is an added part integral with the body of the rotor (1), being housed in a recess made in the body (2).

5. The rotor of claim 4, wherein said at least one lateral means of axial maintaining (3, 3a) is machined in the mass of the body (2) of the rotor (1) or glued, welded, screwed or crimped to the body (2) of the rotor (1).

6. The rotor (1) of claim 4, wherein said at least one lateral means of axial maintaining (3, 3a) comprises one or several branches (3), the or each branch (3) being secured with the body (2) and separating said at least two semi-embedded magnets (2a) in a respective interval, the or each branch (3) comprising at least one tenon (3a) extending as an ortho-radial protrusion from the branch (3) and covering at least one portion of a face of at least one of said at least two semi-embedded magnets (2a) located the farthest away from and opposite the support face of the body (2), said at least one tenon (3a) abutting against the magnet (2a) preventing a separation movement of the magnet (2a) in the axial direction of the body (2).

7. The rotor of claim 6, wherein each one of said at least two semi-embedded magnets is associated with at least two tenons (3a).

8. The rotor (1) of claim 6, wherein each tenon (3a) extends laterally from the two sides of the associated branch (3), a first lateral portion of the tenon (3a) covering at least one portion of one magnet of said at least two semi-embedded magnets (2a) and a second lateral portion of the tenon (3a) covering at least one portion of the other magnet.

9. The rotor (1) of claim 6, wherein, when the rotor (1) comprises a means of outer radial maintaining (6) in the form of a ring extending all around the outer periphery of the body (2), the means for outer radial maintaining (6) is respectively connected to each branch (3), with portions (6a) in an arc or circle of the means of outer radial maintaining (6) forming an abutment against a radial and axial displacement of one of said at least two semi-embedded magnets (2a).

10. The rotor (1) of claim 1, wherein, when the rotor (1) does not comprise a means of outer radial maintaining (6) extending all around the outer periphery of the body (2), the rotor (1) is surrounded by a circular fret (4).

11. The rotor (1) of claim 1, wherein, when the body (2) comprises one or several branches (3) separating said at least two semi-embedded magnets (2a) in a respective interval and a means of inner (5a) and/or outer (6a) radial maintaining, the means of inner (5a) and/or outer (6a) radial maintaining is secured with the or each branch (3).

12. The rotor (1) of claim 1, wherein said at least two semi-embedded magnets are of a different shape and/or comprised of several parts forming magnetic poles or are part of a single-piece structure that has several magnetic poles.

13. The rotor (1) of claim 1, wherein said at least two semi-embedded magnets (2a) are in the form of quadrangular tiles with two sides of said at least two semi-embedded magnets (2a) extending radially and two inner and outer sides of said at least two semi-embedded magnets (2a) extending in concentric arcs of a circle at the centre of the disc formed by the body (2).

14. The rotor (1) of claim 1, wherein the two circular faces of the body (2) of the rotor (1) each comprise at least two semi-embedded magnets (2a).

15. The rotor (1) of claim 1, wherein at least one single-piece circular structure is formed from said at least two semi-embedded magnets (2a), the single-piece structure in the case of a single single-piece structure forming a circular ring on a circular face of the body (2) or two single-piece structures in the case of several single-piece structure forming two concentric circular rings of semi-embedded magnets of which one on each one of the two circular faces of the body (2), with the two single-piece structures being spaced apart by a separation element that is part of the body (2) of the rotor (1), said at least two semi-embedded magnets (2a) of the single-piece structure or of the two single-piece structures in the form of rings being maintained by a lateral means of axial maintaining (3, 3a) or by a means of axial maintaining (5a, 6a) forming a ring, where applicable with a means of radial maintaining (5, 6) forming a ring.
